(19) United States
(12) Patent Application Publication
(10) Pub. No.: US 2006/0110508 A1
(43) Pub. Date: May 25, 2006

(54) Method for preparing dried alpha-rice by vacuum drying

(75) Inventors: Chulbae Choi, Seoul (KR); Kyusik Choi, Seoul (KR); Kyungho Choi, Korea (KR); Kwangsung Han, Korea (KR); Hwajin An, Korea (KR)

Correspondence Address: VENABLE LLP, P.O. BOX 34385, WASHINGTON, DC, 20045-9998, US

(73) Assignee: Bulro Corp., Gyeongsangnamdo (KR)

(21) Appl. No.: 10/525,842

(22) PCT Filed: Apr. 21, 2003
(86) PCT No.: PCT/KR03/00809

§ 371 Date: Sep. 19, 2005

(30) Foreign Application Priority Data
Aug. 26, 2002 (KR) 10-2002-0050450

(51) Int. Cl. A23L 1/10

(52) U.S. Cl. 426/462

(57) ABSTRACT

The present invention relates to a method for preparing dried alpha-rice by vacuum drying comprising: (a) washing out impurities from the surface of hulled-rice by using a washing device; (b) immersing the washed rice in water for 3 to 120 minutes to contain water uniformly, and then drying it naturally for 3 to 30 minutes; (c) putting the soaked rice into an auto conveyor rice cooker, wherein the temperature of water is maintained at 80 to 98% C, and then scalding it for 8 to 20 minutes to be boiled rice; (d) cooling the boiled rice rapidly by shower at first, and then washing out it in a cooling tank secondly; and (e) putting the boiled rice into a vacuum drying room, which temperature is maintained at 60 to 98% C, and reducing the internal pressure to below 1 Torr, and then vacuum drying the boiled rice until its water content becomes less 5%.

### TECHNICAL FIELD

The present invention relates to a method for preparing dried alpha-rice by a vacuum drying process. More particularly, the present invention relates to a method for preparing dried alpha-rice comprising converting starch of rice into alpha-form starch and rapidly vacuum drying to fix the alpha-form starch, thereby conveniently eating at any time and place without having to perform any cooking operations.

### BACKGROUND ART

Various life styles in modern society lead to changes in dietary patterns. In particular, as daily schedules become busier and leisure activities are increasingly pursued, light meals are required. For this reason, instant foods, e.g., fast food, have been developed.

Cooking of raw rice, which is the staple food for Koreans, has been prepared by traditional cooking operations for several thousand years. The traditional cooking operations are mainly performed in the home by washing rice with water in all seasons, if necessary, soaking the washed rice in water for a few minutes, and boiling the washed rice using firewood, electricity, gas, etc., as a heat source. Ready-to-eat rice products consumed during leisure activities such as mountain climbing, fishing, etc., have been recently developed. Among these products, retort rice, frozen rice, sterile-wrapped rice and the like are commercially available. However, these rice products are troublesome in that additional cooking operations are required to eat them after opening them.

As cultural life changes, new dietary demands are created. Dried alpha-rice satisfies the new dietary demands.

The term “dried alpha-rice” as used herein refers to rice in which the type of starch is converted from beta-form starch (wet starch) to alpha-form starch (modified starch) with unchanged its original crystalline structure. The beta-starch is not easily digested due to its poor affinity to water molecules and enzymes in the body, while alpha-starch is easy to digest due to its susceptibility to enzymatic activities. Generally, rice, potatoes and sweet potatoes are cooked by adding water the thereto, followed by boiling, in order to convert wet starch (beta-starch) into modified starch (alpha-starch) and thus facilitate their digestion in the body.

Various methods for preparing dried rice have been known.

For example, Korean Patent No. 1988-000328, 1994-0002526 and 1994-0000323, etc., propose methods for preparing dried rice. However, according to these methods, since the dried rice is prepared by hot air-drying, transformation such as shrinkage takes place. In addition, there are problems that the restoration to the former state of the dried rice is retarded, and texture of the dried rice is deteriorated. Korean Patent Application No. 93-17678 discloses an improved method for the preparation of dried rice, compared to the above-mentioned methods. However, according to the Patent Application, there may be problems such as reduction in preparation efficiency, loss of a large amount of nutrients, deterioration in quality due to propagation of microorganisms and low product quality. These problems are due to long soaking time.

Therefore, the present invention has been made in view of the above-mentioned problems, and it is an object of the present invention to provide a method for preparing instant dried alpha-rice by a vacuum drying process. According to the method of the present invention, soaking and dehydration time are optimally controlled to ensure productivity and preparation efficiency, cooling and washing are carried out twice following hot water treatment to rapidly fix alpha-starch, and finally vacuum drying is carried out in a drying chamber at a relatively low temperature to prepare instant dried alpha-rice, which is restored to its original state and easily digested. The dried alpha-rice thus prepared is restored in a short time (e.g., 3˜10 minutes) after the addition of hot water. Although cold water is added, the dried alpha-rice is restored within a predetermined time (11˜50 minutes). The restored alpha-rice has appearance and texture comparable to conventional boiled rice.

### DISCLOSURE OF THE INVENTION

In accordance with the present invention, the above and other objects can be accomplished by the provision of a method for preparing instant dried alpha-rice by a vacuum drying process, comprising the steps of:

(a) washing milled rice with water in a washer to remove impurities adhered to the shell of the milled rice;

(b) soaking the washed rice in water for 3˜120 minutes to evenly absorb water, followed by dehydrating in air for 3˜30 minutes;

(c) charging the dehydrated rice into a continuous rice cooker while maintaining the water temperature at 80˜98° C., followed by hot water treating for 8˜20 minutes to prepare boiled rice;

(d) quickly cooling the boiled rice using a shower, followed by washing in a cooling tank; and

(e) placing the washed boiled rice in a vacuum drying chamber while maintaining the internal temperature at 60˜98° C., and vacuum drying at an internal pressure of 1 torr or lower to maintain water content of the boiled rice at 1˜5% or less.

Hereinafter, the method according to the present invention will be explained in more detail based on the respective steps.

[First Step] Washing

Selected raw rice is washed in a washer to completely remove impurities adhered to the shell of the raw rice. As the raw rice, all kinds of rice including non-glutinous rice and glutinous rice may be used.

[Second Step] Soaking and Dehydration

In order to evenly absorb water, soaking is carried out for 3˜120 minutes, preferably 10˜60 minutes, and more preferably 30 minutes; and then dehydration is carried out in air for 3˜30 minutes, preferably 3˜20 minutes, and more preferably 10 minutes.

The soaking time is appropriately adjusted depending on various factors such as water temperature and season. When the soaking is not carried out or is carried out for less than 3 minutes, fissures are formed during hot water treatment, as will hereinafter be described. Since starch and nutritive ingredients of rice leak through the fissures, the appearance of grains of the boiled rice is transformed and the boiled rice becomes too soft. The soft boiled rice makes the separation of the grains difficult and deteriorates the texture of the boiled rice. On the contrary, when the soaking time exceeds 120 minutes, the smell of rice bran is incorporated into the boiled rice, causing malodor of the boiled rice, and furthermore grains of the boiled rice is collapsed, deteriorating texture and taste of the rice.

Considering even absorption of water into the soaked rice and improved productivity, the dehydration time is adjusted within the range of up to 30 minutes.

[Third Step] Hot Water Treatment

The dehydrated rice is charged into a continuous rice cooker while maintaining the water temperature at 80˜98° C., preferably 90˜98° C., and more preferably 95° C. Subsequently, hot water treatment is carried out for 8˜20 minutes, preferably 8˜15 minutes, and more preferably 12 minutes to prepare boiled rice.

When the water temperature during hot water treatment is within 80˜98° C., the appearance of grains of the boiled rice is maintained to be constant. In addition, since starch is completely converted into alpha-starch, no deterioration in texture takes place and nutrient losses are minimized. Furthermore, grains of final alpha-rice to be prepared after vacuum drying, which will be described below, can be easily separated, and good texture of the final alpha-rice can be obtained. On the other hand, when the water temperature exceeds 98° C., starch is easily removed but the appearance of grains of the boiled rice is easily transformed due to excessive hot water. Accordingly, it is undesirable in terms of texture and dietetics.

[Fourth Step] Cooling and Washing

First, the boiled rice is subjected to quick cooling using a shower to fix alpha-form starch, and then washed in a cooling tank to remove starch. The cooling and washing are repeated twice. Grains of final alpha-rice to be prepared after vacuum drying, which will be described below, can be easily separated. The water content of the washed boiled rice amounts to 65% or more, and thus the transformation into beta-starch (aging) is suppressed.

[Fifth Step] Vacuum Drying

The washed boiled rice is placed in a vacuum drying chamber while maintaining the internal temperature at 60˜98° C., and then is subjected to vacuum drying at an internal pressure of 1 torr or lower to maintain water content of the boiled rice at 15% or less.

The internal temperature of the vacuum drying chamber can be controlled within the range of 60˜98° C., depending on properties of dried alpha-rice to be prepared. When drying at a relatively low temperature of 60° C., heat denaturation of proteins and oxidation of lipids contained in the dried alpha-rice are inhibited, and thus good color, flavor and taste of the dried alpha-rice are attained. On the contrary, when drying at a relatively high temperature of 98° C., savory and tasty alpha-rice can be prepared due to roasting effect.

The dried alpha-rice thus prepared has an alpha-starch content of 92% or higher, and maintains its original appearance. The alpha-starch content influences taste and digestibility of the dried alpha-rice. The alpha-starch content herein is determined using a diastase digestion method.

The diastase digestion method is commonly used to measure modification of starch, in a word, hydrolysis of starch by starch hydrolase (digestibility). Generally, starch products having high alpha-starch content are susceptible to starch hydrolase, which implies good digestibility in the body.

### BEST MODE FOR CARRYING OUT THE INVENTION

The method for preparing instant dried alpha-rice according to the present invention is illustrated in greater detail below with reference to Examples.

### EXAMPLE 1

After raw rice was washed with water in a washer, the washed rice was soaked in water for 3 minutes and then dehydrated in air for 30 minutes. The dehydrated rice was hot water treated with water at 80° C. for 20 minutes. Subsequently, the boiled rice was subjected to quick cooling in cold water at 5° C., and then washed in a cooling tank at 20° C. The washed boiled rice was placed in a vacuum drying chamber at an internal temperature of 60° C., and then subjected to vacuum drying at an internal pressure of 1 torr or lower.

### EXAMPLE 2

After raw rice was washed with water in a washer, the washed rice was soaked in water for 10 minutes and then dehydrated in air for 25 minutes. The dehydrated rice was hot water treated with water at 85° C. for 18 minutes. Subsequently, the boiled rice was subjected to quick cooling in cold water at 5° C., and then washed in a cooling tank at 20° C. The washed boiled rice was placed in a vacuum drying chamber at an internal temperature of 70° C., and then subjected to vacuum drying at an internal pressure of 1 torr or lower.

### EXAMPLE 3

After raw rice was washed with water in a washer, the washed rice was soaked in water for 20 minutes and then dehydrated in air for 20 minutes. The dehydrated rice was hot water treated with water at 90° C. for 15 minutes. Subsequently, the boiled rice was subjected to quick cooling in cold water at 5° C., and then washed in a cooling tank at 20° C. The washed boiled rice was placed in a vacuum drying chamber at an internal temperature of 80° C., and then subjected to vacuum drying at an internal pressure of 1 torr or lower.

### EXAMPLE 4

After raw rice was washed with water in a washer, the washed rice was soaked in water for 30 minutes and then dehydrated in air for 10 minutes. The dehydrated rice was hot water treated with water at 95° C. for 13 minutes. Subsequently, the boiled rice was subjected to quick cooling in cold water at 5° C., and then washed in a cooling tank at 20° C. The washed boiled rice was placed in a vacuum drying chamber at an internal temperature of 90° C., and then subjected to vacuum drying at an internal pressure of 1 torr or lower.

### EXAMPLE 5

After raw rice was washed with water in a washer, the washed rice was soaked in water for 120 minutes and then dehydrated in air for 3 minutes. The dehydrated rice was hot water treated with water at 98° C. for 10 minutes. Subsequently, the boiled rice was subjected to quick cooling in cold water at 5° C., and then washed in a cooling tank at 20° C. The washed boiled rice was placed in a vacuum drying chamber at an internal temperature of 98° C., and then subjected to vacuum drying at an internal pressure of 1 torr or lower.

### COMPARATIVE EXAMPLE 1

After raw rice was washed with water in a washer, the washed rice was soaked in water for 1 minute and then dehydrated in air for 40 minutes. The dehydrated rice was hot water treated with water at 75° C. for 7 minutes. Subsequently, the boiled rice was washed in a cooling tank at 20° C. The washed boiled rice was placed in a vacuum drying chamber at an internal temperature of 90° C., and then subjected to vacuum drying at an internal pressure of 1 torr or lower.

### COMPARATIVE EXAMPLE 2

After raw rice was washed with water in a washer, the washed rice was soaked in water for 130 minutes and then dehydrated in air for 2 minutes. The dehydrated rice was hot water treated with water at 100° C. for 22 minutes. Subsequently, the boiled rice was washed in a cooling tank at 20° C. The washed boiled rice was placed in a vacuum drying chamber at an internal temperature of 90° C., and then subjected to vacuum drying at an internal pressure of 1 torr or lower.

### COMPARATIVE EXAMPLE 3

After raw rice was washed with water in a washer, the washed rice was soaked in water for 240 minutes and then dehydrated in air for 30 minutes. The dehydrated rice was hot water treated with water at 100° C. for 20 minutes. Subsequently, the boiled rice was washed in a cooling tank at 20° C. The washed boiled rice was placed in a vacuum drying chamber at an internal temperature of 90° C., and then subjected to vacuum drying at an internal pressure of 1 torr or lower.

Preparing conditions for the respective Examples 1˜5 and Comparative Examples 13 are shown in Table 1 below.

TABLE 1

| | Steps | | | | | | |
|---|---|---|---|---|---|---|---|
| | | | | | Cooling | | Vacuum |
| | | | | | temperature | | drying |
| | Soaking | Dehydration | Hot water treatment | | Cold | Cooling | Internal |
| | Time | Time | Temp. | Time | water | tank | temp. |
| Examples | (min.) | (min.) | (° C.) | (min.) | (° C.) | (° C.) | (° C.) |
| Example 1 | 3 | 30 | 80 | 20 | 5 | 20 | 60 |
| Example 2 | 10 | 25 | 85 | 18 | 5 | 20 | 70 |
| Example 3 | 20 | 20 | 90 | 15 | 5 | 20 | 80 |
| Example 4 | 30 | 10 | 95 | 13 | 5 | 20 | 90 |
| Example 5 | 120 | 3 | 98 | 10 | 5 | 20 | 98 |
| Comp. Exam. 1 | 1 | 40 | 75 | 7 | — | 20 | 90 |
| Comp. Exam. 2 | 130 | 2 | 100 | 22 | — | 20 | 90 |
| Comp. Exam. 3 | 240 | 30 | 100 | 20 | — | 20 | 90 |

Changes in pH values, solid contents and ingredient contents of the soaked rice in Examples and Comparative Examples, respectively, were measured. The change in pH values of soaking solutions was measured by a pH-meter. The change in solid contents was calculated by subtracting the weight of dried rice from the weight of raw rice. The weight of the dried rice was obtained by drying the soaked rice at room temperature for 2 hours, followed by at 30° C. for 10 hours. The protein, fat and ash contents in the soaked rice were determined in accordance with the AOAC standard method. The results are shown in Table 2 below.

TABLE 2
Test results on soaked rice over soaking time

| | Items | | | | | |
|---|---|---|---|---|---|---|
| | | Solid | Ingredients (%) | | | |
| | | loss | Crude | Crude | Crude | Sensory |
| Examples | pH | (%) | proteins | fat | ash | Test |
| Example 1 | 6.74 | 0.4 | 8.5 | 0.86 | 0.58 | Good |
| Example 2 | 6.66 | 0.6 | 8.3 | 0.82 | 0.50 | Good |
| Example 3 | 6.53 | 1.0 | 8.1 | 0.80 | 0.42 | Good |
| Example 4 | 6.42 | 1.2 | 8.0 | 0.77 | 0.40 | Good |
| Example 5 | 6.01 | 2.3 | 7.7 | 0.69 | 0.31 | Good |
| Comp. Exam. 1 | 6.80 | 0.4 | 8.5 | 0.87 | 0.59 | Good |
| Comp. Exam. 2 | 5.80 | 2.5 | 6.2 | 0.65 | 0.23 | Smell of |
| | | | | | | rice bran |
| Comp. Exam. 3 | 4.92 | 3.7 | 5.6 | 0.62 | 0.21 | Abnormal |
| | | | | | | odor |

As can be seen from Examples and Comparative Examples, pH values of soaking solutions were decreased as the soaking time increased, and losses in solid content were increased. The protein contents were considerably decreased 120 minutes after soaking; the fat contents were slightly decreased 120 minutes after soaking, but thereafter no changes were observed; and the ash contents were linearly decreased for 120 minutes after soaking, and then slowly decreased.

Sensory tests on instant dried alpha-rice prepared in Examples and Comparative Examples were performed. The results are shown in Tables 3 and 4 below.

TABLE 3
Results of sensory tests on instant dried alpha-rice

| | Items | | | |
|---|---|---|---|---|
| | Sensory tests (9-point scale) | | | |
| Examples | Taste | Texture | Smell | Total sensory evaluation |
| Example 1 | 8.4 | 8.3 | 8.7 | 8.4 |
| Example 2 | 8.1 | 8.2 | 8.5 | 8.2 |
| Example 3 | 8.2 | 8.0 | 8.2 | 8.0 |
| Example 4 | 8.0 | 7.9 | 8.0 | 7.9 |
| Example 5 | 7.9 | 8.1 | 7.8 | 7.8 |
| Comp. Exam. 1 | 6.5 | 6.2 | 7.7 | 6.9 |
| Comp. Exam. 2 | 6.5 | 6.9 | 6.5 | 6.4 |
| Comp. Exam. 3 | 5.9 | 6.4 | 5.8 | 6.1 |

TABLE 4
Results of sensory tests on instant dried alpha-rice

| | | | Texture |
|---|---|---|---|
| | Separation of | Color and gloss, and | after |
| Examples | grains | appearance | restoration |
| Example 1 | Good | Original color and gloss, and | Good |
| | | good appearance | |
| Example 2 | Good | Original color and gloss, and | Good |
| | | good appearance | |
| Example 3 | Good | Original color and gloss, and | Good |
| | | good appearance | |
| Example 4 | Good | Original color and gloss, and | Good |
| | | good appearance | |
| Example 5 | Good | Bright yellow, no color | Savory |
| | | change, and good appearance | |
| Comp. | Good | Broken grains | Uncooked |
| Exam. 1 | | | texture |
| Comp. | Strong adherence | Collapse and severe shrinkage | Brittle |
| Exam. 2 | between grains | of grains | texture |
| Comp. | Strong adherence | Fracture, collapse and | Brittle |
| Exam. 3 | between grains | agglomeration of grains | texture |

Other physical properties of the dried rice were measured. The results are shown in Table 5 below.

TABLE 5
Experimental results of instant dried alpha-rice

| | | | Alpha- | | | | | | | |
|---|---|---|---|---|---|---|---|---|---|---|
| | Fracture | Water | starch | Water absorption rate (water weight %) | | | | | | |
| | of grains | absorptance | content | | | | | 10 | 12 | 14 |
| Examples | (%) | (%) | (%) | 2 min. | 4 min. | 6 min. | 8 min. | min. | min. | min. |
| Exam. 1 | 7 | 365 | 92.4 | 52.4 | 58.2 | 63.5 | 67.8 | 68.4 | 70.3 | 72.4 |
| Exam. 2 | 6 | 370 | 93.2 | 51.7 | 57.2 | 62.6 | 66.4 | 67.9 | 69.4 | 72.2 |
| Exam. 3 | 6 | 375 | 93.7 | 50.5 | 55.5 | 61.5 | 64.8 | 64.5 | 67.2 | 69.0 |
| Exam. 4 | 8 | 380 | 95.4 | 53.4 | 59.2 | 64.9 | 68.2 | 69.5 | 71.2 | 74.4 |
| Exam. 5 | 9 | 384 | 92.0 | 48.5 | 52.8 | 53.4 | 59.8 | 62.0 | 66.1 | 68.1 |
| Comp. | 7 | 350 | 79.4 | 44.6 | 46.3 | 52.6 | 56.8 | 60.1 | 62.7 | 64.8 |
| Exam. 1 | | | | | | | | | | |
| Comp. | 11 | 371 | 88.2 | 45.8 | 47.4 | 53.7 | 58.6 | 61.8 | 64.6 | 66.2 |
| Exam. 2 | | | | | | | | | | |
| Comp. | 13 | 360 | 85.5 | 44.9 | 46.5 | 50.5 | 54.9 | 56.8 | 57.8 | 60.4 |
| Exam. 3 | | | | | | | | | | |

These examples are given for the purpose of illustration and are not to be construed as limiting the scope of the invention. Accordingly, those skilled in the art will appreciate that various modifications are possible, without departing from the scope and spirit of the invention as disclosed in the accompanying claims.

### INDUSTRIAL APPLICABILITY

In accordance with the method for preparing dried alpha-rice of the present invention, soaking and dehydration time, and conditions for hot water treatment and vacuum drying are optimally controlled to ensure preparation efficiency of the dried alpha-rice. In addition, due to minimized ingredients losses, nutritional value and quality of product are greatly improved, and a risk of deterioration in quality is reduced. In particular, short soaking time in the method for preparing dried alpha-rice makes it possible to maintain the appearance of grains of the boiled rice to be constant and reduce shrinkage of grains. Furthermore, the method for preparing dried alpha-rice of the present invention facilitates the separation of grains, reduces fracture of grains, and imparts porous structures, thereby increasing water absorption rate closely associated with restoration. Quick cooling and drying in the method for preparing dried alpha-rice make it possible to increase alpha-starch content closely associated with digestibility in the body.

What is claimed is:

1. A method for preparing instant dried alpha-rice, comprising the steps of:
(a) washing milled rice with water in a washer to remove impurities adhered to the shell of the milled rice;
(b) soaking the washed rice in water for 3˜120 minutes to evenly absorb water, followed by dehydrating in air for 3˜30 minutes;
(c) charging the dehydrated rice into a continuous rice cooker while maintaining the water temperature at 80˜98° C., followed by hot water treating for 8˜20 minutes to prepare boiled rice;
(d) quickly cooling the boiled rice using a shower, followed by washing in a cooling tank; and
(e) placing the washed boiled rice in a vacuum drying chamber while maintaining the internal temperature at 60˜98° C., and vacuum drying at an internal pressure of 1 torr or lower to maintain water content of the boiled rice at 1˜5% or less.

2. The method for preparing instant dried alpha-rice according to claim 1, wherein the soaking is carried out for 10˜60 minutes, and the dehydration is carried out in air for 3˜20 minutes.

3. The method for preparing instant dried alpha-rice according to claim 1, wherein the dehydrated rice is charged into a continuous rice cooker while maintaining the water temperature at 90˜98° C., and the hot water treatment is carried out for 8˜15 minutes to prepare boiled rice.

4. The method for preparing instant dried alpha-rice by a vacuum drying process according to claim 1, wherein the dried alpha-rice has an alpha-starch content of 92% or higher.
